(19) United States
(12) Patent Application Publication
(10) Pub. No.: US 2019/0082881 A1
(43) Pub. Date: Mar. 21, 2019

(54) SYSTEM AND METHOD FOR BREWING A CUP OF COFFEE

(71) Applicant: Mere Coffee, Inc., San Francisco, CA (US)

(72) Inventors: Scott Steber, San Francisco, CA (US); Greg Kress, San Francisco, CA (US); Michael Chiasson, San Francisco, CA (US); Eric Hale, San Francisco, CA (US); Maya Kelley, San Francisco, CA (US); Agustus Shelander, San Francisco, CA (US); Brentley Wiles, San Francisco, CA (US)

(21) Appl. No.: 15/923,215

(22) Filed: Mar. 16, 2018

Related U.S. Application Data
(60) Provisional application No. 62/472,652, filed on Mar. 17, 2017.

(51) Int. Cl. A47J 31/42; A47J 31/44; A47J 31/46; A47J 31/54; A47J 31/52

(52) U.S. Cl. CPC A47J 31/42; A47J 31/4403; A47J 31/52; A47J 31/4492; A47J 31/542; A47J 31/468

(57) ABSTRACT

One variation of a method includes, at a system configured to brew a cup of coffee: reading an identifier from a packet; accessing a brew recipe based on the identifier; triggering a door actuator to open an inlet door on the system; initiating a brew cycle according to the brew recipe; during the brew cycle, activating a grinder for a grind duration to grind whole beans dispensed from the packet through the inlet door in response to manual closure of the inlet door, dispensing coffee grounds from the grinder into a brew chamber, heating a volume of water to a target temperature specified in the brew recipe, dispensing the volume of water into the brew chamber, and agitating the volume of water and coffee grounds in the brew chamber; and transferring fluid out of the brew chamber in response to conclusion of the brew cycle.

### CROSS-REFERENCE TO RELATED APPLICATIONS

This Application claims the benefit of U.S. Provisional Application No. 62/472,652, filed on 17 Mar. 2017, which is incorporated in its entirety by this reference

### TECHNICAL FIELD

This invention relates generally to the field of coffee brewing and more specifically to a new and useful system and method for brewing a cup of coffee in the field of coffee brewing.

### BRIEF DESCRIPTION OF THE FIGURES

FIG. 1 is a schematic representation of a system;

FIG. 2 is a schematic representation of one variation of the system;

FIG. 3 is a schematic representation of one variation of the system; and

FIG. 4 is a flowchart representation of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

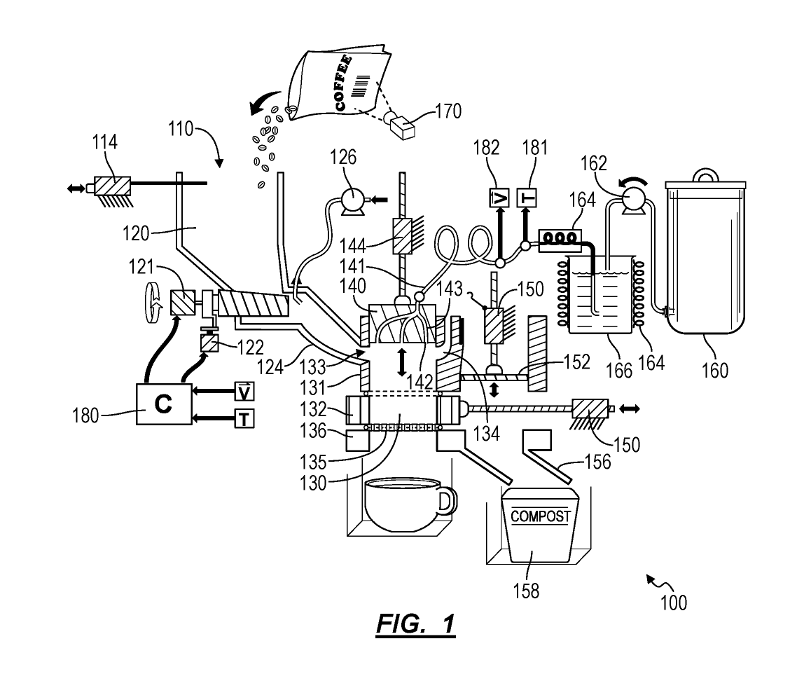

As shown in FIGS. 1, 2, and 3, a system 100 for brewing a cup of coffee includes: a whole bean inlet 110; a grinder 120 configured to grind whole coffee beans, dispensed into the whole bean inlet 110, into coffee grounds; and a ground duct 124 extending from an outlet of the grinder 120. The system 100 also includes a brew chamber 130 defined by: a filter 135; a fixed chamber section 131 offset above the filter 135, defining a fixed chamber section 131 coaxial with the filter 135, and defining a ground window 133 configured to receive grounds from the ground duct 124; and a mobile chamber section 132 interposed between the filter 135 and the fixed chamber section 131, defining a mobile chamber section 132, and operable between a brew position in which the mobile chamber section 132 is coaxial with the fixed chamber section 131 and a discard position in which the mobile chamber section 132 is offset from the fixed chamber section 131. The system 100 further includes: an air supply 126 coupled to the ground duct 124 and configured to impel grounds output by the grinder 120 toward the ground window 133; a piston 140 configured to run along the fixed chamber section 131 and the mobile chamber section 132 and defining a fluid inlet 141 opposite the filter 135, a set of fluid outlets 142 facing the filter 135, and a manifold 143 configured to distribute fluid from the fluid inlet 141 into the brew chamber 130 via the set of fluid outlets 142; and a brew chamber actuator 144 configured to draw the piston 140 away from the filter 135 to draw air through the filter 135 into the brew chamber 130 during a brew cycle and to advance the piston 140 toward the filter 135 to drive fluid out of the brew chamber 130 through the filter 135 in response to conclusion of the brew cycle.

The system 100 can also include: an inlet door arranged across the whole bean inlet 110; a door actuator 114 configured to open the inlet door; a scanner 170 configured to read an identifier from a packet proximal the whole bean inlet 110; a water reservoir 160 configured to store water at room temperature; a heating element 164 configured to heat water drawn out of the reservoir; a buffer tank 166 configured to heat and store water received from the water reservoir 160; and a displacement system (e.g., a pump 162) configured to move water from the water reservoir 160 into the buffer tank 166 and from the buffer tank 166 into the brew chamber 130.

The system 100 can further include a controller 180 configured to control various actuators within the system 100 to execute a brew cycle when a new packet of whole coffee beans in scanned and its contents then dispensed into the whole bean inlet 110. In particular, the controller 180 can: access a brew recipe based on an identifier read from this packet; trigger the door actuator 114 to open the inlet door in response to the brew recipe indicating whole coffee beans in the packet; and initiate a brew cycle according to the brew recipe in response to manual closure of the inlet door. During the brew cycle, the controller 180 can: activate the grinder 120 for a grind duration to grind whole beans manually dispensed from the packet into the whole bean inlet 110 via the inlet door; activate the heating element 164 to heat a volume of water to a target temperature specified in the brew recipe; activate the pump 162 to dispense the volume of water into the brew chamber 130 via the inlet; and activate the brew chamber actuator 144 to retract the piston 140 from the filter 135 to draw air into the brew chamber 130 to agitate the volume of water and coffee grounds in the brew chamber 130. In response to conclusion of the brew cycle, the controller 180 can then activate the brew chamber actuator 144 to advance the piston 140 toward the filter 135 to transfer fluid out of the brew chamber 130 via the filter 135.

### 2. Applications

Generally, the system 100 defines a coffee machine configured to automatically: identify whole coffee beans dispensed thereinto; retrieve a brew recipe specifying various brew parameters; grind these beans according to a ground size specified in the brew recipe; immediately brew the resulting coffee grounds according to a water temperature, brew ratio, water dispensation profile, brew chamber agitation, and/or steep duration specified in the brew recipe; dispense brewed coffee into a cup (or pot, etc.); and then discard the loose, used coffee grounds into a waste bin 158 (e.g., a compost bin). In particular, the system 100 accepts whole coffee beans, grinds these beans immediately before brewing and according to a ground size specified by the brew recipe, and brews these loose grounds according to time, water volume, and temperature parameters specified in the brew recipe, thereby enabling repeatable and accurate extraction of target flavors from this coffee bean over multiple servings at multiple instances of the system 100 over time. For example, a coffee roaster may specify a unique set of brew parameters for its coffee beans, such as unique to even a single batch of roasted coffee beans, that yields a target flavor profile “designed” and desired by the roaster; these parameters can be associated with or written into barcodes printed onto packets containing single servings of whole coffee beans from this batch. The system 100 can retrieve these brew parameters when such packets are identified and then implement these brew parameters to transform a serving of whole coffee beans in the packet into a single cup of coffee that accurately and repeatably exhibits the target flavor profile designed by the roaster (or tailored to a user's preferences).

Generally, coffee grounds exhibit significantly more surface area than whole beans; oxidation of a coffee bean and coffee grounds may be characterized as a function of surface area; accelerated exposure resulting from grinding may therefore yield oxidation of acids, aromatics, and oils in the coffee bean, thereby reducing or eliminating desired flavors and resulting in a bland and/or unbalanced cup of coffee brewed with coffee grounds ground significantly before being brewed. Therefore, by accepting and grinding whole coffee beans just prior to brewing, the system 100 can achieve a desired balance of acids, aromatics, and oils in these grounds, which may yield a flavorful and well-balanced cup of coffee.

The system 100 is described below as accepting whole coffee beans, grinding and brewing these coffee beans, and dispensing coffee into a cup. However, the system 100 can similarly brew a cup of tea, cocoa, apple cider, masala chai, or espresso, etc., such as by accepting, grinding, and/or brewing whole tea leaves, cocoa beans, dried apple, etc. The system 100 can also brew coffee from pre-ground beans dispensed into the system 100.

### 3. Recipe Retrieval

As shown in FIG. 1, the system 100 includes a scanner 170 configured to read an identifier (or “ID”) from a packet containing whole coffee beans. For example, a serving of whole coffee beans (e.g., a quantity or weight of whole coffee beans sufficient to brew one cup of coffee) can be stored and sealed inside a packet including a compostable paper pouch. (Alternatively, the packet can include a box, carton, tube, can, cup, or other container.) Textual information about coffee beans contained inside (e.g., name, origin, roaster, roast date, prominent flavors and aromas, etc.) the packet and a one-dimensional barcode containing identifying information of these coffee beans can be printed directly onto the packet or printed onto compostable stickers that are then applied to the packet. In this example, the scanner 170 can include a one-dimensional optical barcode scanner 170; when the packet is held in view of the scanner 170, the scanner 170 can extract identifying information from the barcode, such as in the form of an alphanumeric code, and pass this code to a controller 180 in the system 100. Upon receipt of this code, the controller 180 can extract a brew recipe directly from the code, such as including: ground size; water temperature; water volume; steep duration; and an agitation profile specified by the roaster. Alternatively, the controller 180 can pass the code through a name mapping system—such as at a remote server via an Internet or cellular connection or stored in a local cache of recipes—to access the brew recipe.

In other implementations, the packet includes a quick-response code or an RFID tag containing identifying information and/or a brew recipe for beans contained in the packet; and the scanner 170 can include a two-dimensional barcode scanner 170 or an RFID reader configured to wirelessly access these identifying information and/or brew recipe data from the packet. However, the scanner 170 can be of any other type and configured to retrieve identifying information and/or brew recipe data from a packet—containing a single serving of whole coffee beans—in any way, such as through optical character recognition of an alphanumeric label applied to the packet, a color detection of a color code applied to the packet, etc.

Generally, the system 100 can interface with single-serving packets containing a quantity of whole coffee beans sufficient to brew a single cup of coffee. For example, the single serving packet can include: a compostable, sealed wax paper (or biopolymer-lined paper) pouch containing approximately thirty grams of coffee beans; and a barcode (or quick response code or other identifier) printed on the exterior of the pouch. In this example, the pouch can include a perforated or folded region to indicate a tear line and assist tearing across a mouth of the pouch. Alternatively, the pouch can include notches on each side of its mouth to assist tearing of the pouch across its mouth. Furthermore, in this example, the barcode (or other identifier) can be arranged across this tear line such that the barcode is destroyed when the pouch is torn open, thereby preventing future reuse of the pouch to initiate a brew cycle with coffee beans not sourced from the pouch itself. In one variation, the system further includes a packet dispenser from which a user may retrieve a packet and which directly transmits a packet identifier to the controller 180.

Alternatively, the barcode (or other identifier) can include a (substantially) unique identifier that uniquely identifies the individual packet; when the system 100 scans the packet, as described above, the system 100 can thus: check this unique identifier against a local database of unique identifiers previously read from other packets at the system 100; and/or check this unique identifier against a global database—stored remotely from the system 100—of unique identifiers previously read from other packets across many other instances of the system 100 to confirm that the packet is new and previously unused. If the system 100 thus confirms that the packet is new and previously unused, the system 100 can retrieve a brew recipe for the coffee beans contained in this packet, trigger the whole bean inlet 110 to open, and execute a brew cycle to brew a single cup of coffee from these whole coffee beans, as described below.

Alternatively, if the system 100 determines that a unique identifier has been scanned a second time (or “reused”), the system 100 can execute a brew recipe associated with this unique identifier but also report this behavior back to a remote server.

However, the system 100 can identify whole or pre-ground beans—dispensed from packaging of any other type or format—in any other way.

### 4. Fluid System

As shown in FIG. 1, the system 100 also includes a fluid system configured to store, heat, and dispense fluid during a brew cycle. In one implementation, the fluid system includes: a reservoir (e.g., a glass or stainless steel tank) configured to hold room-temperature water; a sealed buffer tank 166 (e.g., a stainless steel or chrome-plated brass tank); a heating element 164 thermally coupled to the buffer tank 166 and configured to heat fluid contained within the buffer tank 166; a reservoir sump extending from the reservoir to the buffer tank 166; a first temperature sensor 181 configured to output a signal corresponding to a temperature of fluid contained in the buffer tank 166; and a pump 162 (e.g., a positive-displacement pump, such as centrifugal or peristaltic pump) configured to pump fluid from the reservoir, through the reservoir sump, and into the buffer tank 166, thereby increasing pressure within the buffer tank 166.

In this implementation, the fluid system also includes: an inline heating element 164 fluidly configured to heat fluid passing therethrough to a target brew temperature; a buffer sump extending from proximal the top of the buffer tank 166 to the inline heating element 164 and remote from the reservoir sump; a flexible fluid line (e.g., a silicone tube) fluidly coupling the inline heating element 164 to a fluid inlet 141 arranged on the back side of the piston 140 (as described below) and configured to absorb variations in distance between the inline heating element 164 and the piston 140 as the piston 140 is advanced and retracted during a brew cycle; a flow meter 182 configured to output a signal corresponding to a volume flow rate of water displaced into the brew chamber 130 (i.e., via the fluid inlet 141 at the piston 140); and a second temperature sensor 181 configured to output a signal corresponding to a temperature of fluid exiting the inline heating element 164. (Alternatively, the flow meter 182 can be arranged between the reservoir and the buffer tank can can be configured to output a signal corresponding to a volume flow rate of water displaced into the buffer tank, which may correspond to a volume flow rate of water displaced into the brew chamber 130.) Thus, when the pump 162 pumps water from the reservoir into the buffer tank 166, the buffer tank 166 can fill with water up to the buffer sump as air exits the buffer tank 166 through the piston 140. With the buffer tank 166 full of heated water, the pump 162 can further pump cool(er) water from the reservoir into the bottom of the buffer tank 166, and heated water—not substantially mixed with this cool(er) water—near the top of the buffer tank 166 can enter the buffer sump and pass through the piston 140 and into the brew chamber 130.

The controller 180 can control the tank heating element 164, the inline heating element 164, the pump 162, and other actuators within the system 100 based on preset system parameters, brew parameters specific to a current brew cycle, and signals output by various sensors within the system 100. In particular, the controller 180 can implement closed-loop controls to selectively activate the tank heating element 164 to maintain fluid in the buffer tank 166 at a preset preheat temperature (e.g., 150° F.) above an ambient temperature (e.g., 70° F.) but below a minimum brew temperature (e.g., 175° F.) based on outputs of the first temperature sensor 181 while the system 100 is in standby (i.e., not executing a brew cycle), thereby enabling the inline heating element 164 to heat fluid—pumped from the buffer tank 166 to the fluid inlet 141 at the piston 140—to a target brew temperature during a brew cycle while also maintaining power consumption of the system 100 to a reasonable level while the system 100 is in standby. Furthermore, during a brew cycle, the controller 180 can: access a target fluid volume (e.g., based on a target ratio of coffee grounds to water) for the brew cycle from the brew recipe; integrate signals output by the flow meter 182 over time to track a volume of fluid passing through the flow meter 182; and selectively activate the pump 162—to displace cooler fluid from the reservoir into the buffer tank 166, thereby displacing heated fluid from the buffer tank 166 into the inline heating element 164 and on to the fluid inlet 141 at the piston 140—until the target volume of fluid has passed through the flow meter 182.

Furthermore, while pumping fluid through the inline heating element 164 at the beginning of a steep period, the controller 180 can implement closed-loop controls to adjust power output of the inline heating element 164 in order to achieve a target brew temperature (e.g., between 175° and 195° F., as specified in a brew recipe for the current brew cycle) in fluid exiting the inline heating element 164. For example, while the pump 162 is active and cool(er) water from the reservoir (or tap) is introduced into the buffer tank 166, which reduces the temperature of water in the buffer tank 166, the controller 180 can implement closed loops controls to adjust the power output of the inline heating element 164 to achieve the target brew temperature while also maximizing the power output of the tank heater up to a maximum combined power consumption between the inline heating element 164 and the tank heater until the temperature of water in the buffer tank 166 reaches the preset preheat temperature.

(In one variation, the controller 180 can intermittently activate and deactivate the pump 162 during a brew cycle to dispense discrete volumes of heated water into the brew chamber 130 over a period of the brew cycle, such as rather than dispense a total brew volume of water into the brew chamber 130 in a single dose.)

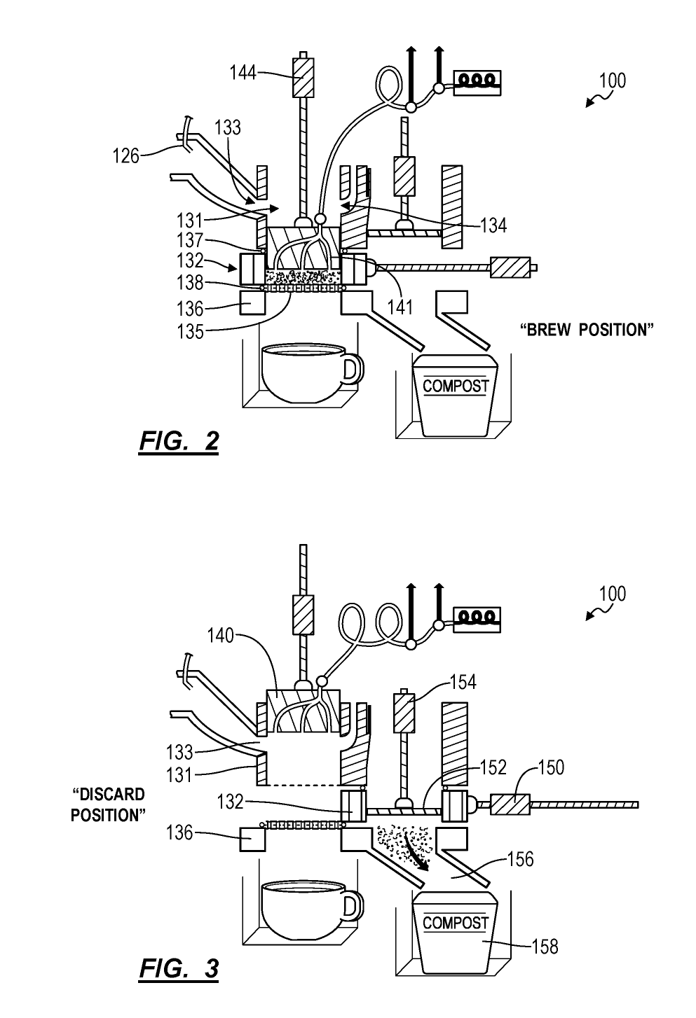

As shown in FIG. 2, the fluid system can also include a check valve interposed between the buffer tank 166 and the piston 140 and configured to permit water to flow through the flexible fluid line and into the piston 140 via the fluid inlet 141 but to prevent fluid from flowing from the piston 140 back toward the buffer tank 166. For example, the check valve can be arranged on the piston 140 between the manifold 143 (described below) and the fluid inlet 141. In another example, the check valve can be interposed between the flexible fluid line and the inline heating element 164.

(Alternatively, the pump 162 can include a peristaltic pump interposed between the buffer tank 166 and the fluid inlet 141 at the piston 140 (e.g., along the flexible fluid line or between the first fluid line and the flexible fluid line) and configured to seal against inbound and outbound fluid flow when inactive, such as: in the presence of fluid pressure exceeding a maximum fluid pressure in the brew chamber 130 as the piston 140 is driven toward the filter 135 to eject fluid from the brew chamber 130 via the filter 135; and in the presence of a vacuum exceeding a maximum vacuum in the brew chamber 130 as the piston 140 is retracted away from the filter 135 to draw air into the brew chamber 130 via openings in the filter 135 to agitate fluid and coffee grounds in the brew chamber 130.)

In one variation, rather than include a reservoir and pump, the fluid system includes: a supply tap configured to receive fluid from a pressurized water supply in a building (e.g., at a kitchen counter); and an actuatable valve interposed between the supply tap and the buffer tank 166. During a brew cycle, the controller 180 can selectively trigger the valve to open in order to release fresh water from the pressurized water supply into the buffer tank 166, thereby displacing heated water from the buffer tank 166 to the fluid inlet 141 at the piston 140 via the inline heating element 164 and flexible fluid line.

### 5. Grinder

Generally, the grinder 120 is configured to receive whole coffee beans dispensed into the whole bean inlet no, to grind these coffee beans into coffee grounds, and to dispense these grounds into the ground duct 124, which then funnels these grounds into the brew chamber 130.

In one implementation shown in FIG. 1, the grinder 120 includes: a burr grinder 120 defining an inlet and an outlet; and a primary grinder actuator 121 configured to rotate the burr grinder 120, thereby grinding whole coffee beans at the inlet into coffee grounds upon passing through the outlet. The burr grinder 120 can also be adjustable. For example, the grinder 120 can further include: a secondary grinder actuator 122 configured to adjust relative positions of elements of the burr grinder 120 according to a ground size parameter specified in a brew recipe for a current brew cycle; and a burr position sensor (e.g., an optical encoder) coupled to the secondary grinder actuator 122 or mounted directly to the elements of the burr grinder 120. In this example, before activating the primary grinder actuator 121 at the start of a next brew cycle, the controller 180 can: extract a ground size (e.g., between fine and coarse) from a brew recipe for this brew cycle; retrieve a target position of elements of the burr grinder 120 from a lookup table—stored in local memory—based on this ground size; and then implement closed-loop controls to move the secondary grinder actuator until the burr position sensor indicates that this target position has been reached. The controller 180 can thus interface with the secondary grinder actuator 122 and the burr position sensor to adjust the elements in the grinder 120 such that grounds—ground from whole beans by the grinder 120—exhibit an average ground size (e.g., maximum or average width) approximating a target ground size specified in the brew recipe for the current brew cycle.

In another implementation, the controller 180 sets the grinder 120 to an intermediate ground size position at the conclusion of a preceding grind cycle. At the beginning of a next brew cycle, the controller 180 extracts a target ground size from a brew recipe for this brew cycle; once whole beans are loaded into the whole bean inlet 110 and the whole bean inlet 110 is closed (and once a start button on the system 100—such as adjacent the whole bean inlet 110—is manually selected), the controller 180 can activate the primary grinder actuator 121 to begin grinding whole beans at the intermediate ground size. With the grinder 120 now active, the controller 180 can activate the secondary grinder actuator 122 to (rapidly) adjust the burr grinder 120 to a ground size position specified by the brew recipe, such as within three seconds of activating the primary grinder actuator. The grinder 120 can continue to grind the whole beans—now to the specified ground size—for a preset ground duration (e.g., an additional four seconds). Toward the conclusion of the grind cycle, the controller 180 can reactivate the secondary grinder actuator 122 to adjust the burr grinder 120 back to the intermediate ground size position in preparation for a next brew cycle and then cease operation of the grinder 120. Therefore, the controller 180 can selectively adjust the burr grinder 120 only when the grinder 120 is active, thereby limiting jams in the burr grinder 120, limiting activation of the grinder 120 during one brew cycle to a single ground cycle, and limiting total brew cycle duration. The controller 180 can repeat this process for each subsequent brew cycle.

Therefore: the system 100 includes a start button proximal the whole bean inlet 110; the scanner 170 can include a barcode scanner 170 configured to read a barcode arranged on the packet (e.g., a destructible barcode arranged along a tearable region across a sealed mouth of the packet that contains an amount of whole coffee beans corresponding to a single cup of coffee); and the controller 180 can activate the grinder 120 to grind this amount of whole coffee beans—dispensed from the packet into the whole bean inlet 110—in response to selection of the start button following manual closure of the inlet door.

### 6. Brew Chamber

The brew chamber 130 includes: a filter 135; a fixed chamber section 131 offset above the filter 135, defining an fixed chamber section 131 coaxial with the filter 135, and defining a ground window 133 configured to receive grounds from the ground duct 124; and a mobile chamber section 132 interposed between the filter 135 and the fixed chamber section 131, defining a mobile chamber section 132, and operable between 1) a brew position in which the mobile chamber section 132 is coaxial with the fixed chamber section 131 and 2) a discard position in which the mobile chamber section 132 is offset from the fixed chamber section 131.

### 6.1 Filter

The filter 135 functions: to permit ambient air to enter the brew chamber 130 while retraction of the piston 140 during a steep period of a brew cycle induces a vacuum in the brew chamber 130, thereby agitating coffee grounds and heated water (i.e., a “must”) contained in the brew chamber 130 during the steep period; and to release fluid out of the brew chamber 130 when the piston 140 is advanced toward the filter 135 upon conclusion of the steep period. In particular, when the piston 140 can induce a vacuum in the brew chamber 130 when retracted, which induces a vacuum in the brew chamber 130, this vacuum can draw ambient air through openings in the filter 135, and resulting air bubbles can agitate the must. Such agitation of the must by these air bubbles can improve overall yield and/or efficiency of flavor extraction from the coffee grounds into the water, thereby yielding a more flavorful volume of coffee upon completion of the brew cycle. Such introduction of a small volume of air—including oxygen—bubbled through the must may also yield a limited, controlled amount of oxidation of the must, which may break down or neutralize tannins and stronger flavors present in the must, thereby yielding a volume of brewed coffee that exhibits both a softer mouth feel and an improved balance of flavors, respectively. Advancement of the piston 140 toward the filter 135 upon the conclusion of the steep period within the brew cycle conversely increases pressure within the brew chamber 130, which forces fluid (i.e., coffee) out of the brew chamber 130 via the filter 135 while the filter 135 prevents grounds and other coffee particulate from exiting the brew chamber 130 into a cup below.

In one implementation, the filter 135 defines a perforated sheetmetal (e.g., stainless steel) or metal mesh insert (e.g., a “portafilter 135”). The system 100 can also include a filter housing 136 that: defines a bottom of the brew chamber 130; supports the filter 135 with an inlet face of the filter 135 extending across a first plane; and defines a lower seal 138ing surface at the first plane and encircling the filter 135. For example, the filter housing 136 can include a stainless steel or chrome-plated brass flange defining a bore and a shallow recess around the bore configured to (permanently or transiently) receive and locate a stainless steel portafilter 135. The filter 135 can also include: a spout to direct coffee into a cup below; and disconnect features (e.g., a quarteroturn thread), such as removal, cleaning, and/or replacement of the filter 135 (e.g., for a paper filter 135 or a metal filter 135 of different opening geometry of different opening ratio).

### 6.2 Fixed Chamber Section

Generally, the fixed chamber section 131 defines an upper cylindrical wall arranged in a fixed position over (e.g., coaxial with) the filter 135. With the mobile chamber section 132 in brew position, the upper cylindrical wall of the fixed chamber section 131 cooperates with the filter 135 and the lower cylindrical wall of the mobile chamber section 132 to define a brew chamber 130 configured to hold coffee grounds and heated water (i.e., a must) during a steep period of a brew cycle.

In one implementation, the fixed chamber section 131 includes a stainless steel, glass, or food-safe polymer cylindrical section defining a smooth cylindrical interior wall configured to mate with (e.g., seal against) the piston 140; the piston 140 can thus run inside the cylindrical interior wall to draw ambient air into the brew chamber 130 air via the filter 135 and to dispense fluid out of the brew chamber 130 via the filter 135 at the conclusion of a steep period within a brew cycle.

The fixed chamber section 131 also defines a ground window 133, such as in the form of an opening in the brew chamber 130 facing the ground duct 124. Generally, the ground window 133 couples to the ground duct 124 to pass coffee grounds—dispensed from the grinder 120—into the brew chamber 130, and the bottom edge of the ground window 133 is offset above the filter 135 by a distance sufficient to permit the piston 140 to remain below the lower edge of the ground window 133 when the brew chamber 130 is filled with a serving of coffee grounds and a serving of water and when the piston 140 is retracted to draw air into the brew chamber 130 during a steep period of a brew cycle. In particular, the fixed chamber section 131 can define the bottom edge of the ground window 133 at a distance sufficiently offset above from the filter 135: such that the brew chamber 130 can be filled with a serving of coffee grounds and a serving of water; and such that the piston 140 can be retracted by a rate sufficient to achieve a target rate of ambient air ingress over the duration of the steep period of a brew cycle—which agitates the must—without a lower seal around the piston 140 passing the lower edge of the ground window 133, thereby enabling the controller 180 to maintain control of pressure (e.g., vacuum) within the brew chamber 130 throughout the duration of a steep period.

The fixed chamber section 131 can also include a vent window 134, such as horizontally opposite the ground window 133. Air injected into the ground duct 124 by the air supply 126 and entering the brew chamber 130 via the ground window 133 can thus be drawn across the filter 135 and then exit the brew chamber 130 via the vent window 134, thereby also drawing grounds toward (but not into) the vent window 134 and improving uniform distribution of grounds across the filter 135 prior to addition of water to the brew chamber 130. For example, the fixed chamber section 131 can define the vent window 134 terminating in a vent that curves vertically upward such that grounds blown through the vent window 134 fall back into the brew chamber 130 once the air supply 126 is deactivated before the piston 140 is driven down past the ground and vent window 134s at the start of a steep period. (In one variation in which the lower edge of the vent window 134 is arranged horizontally below the grind window and above a high-water line of the brew chamber 130, a vacuum line can be fluidly coupled to the vent window 134 to draw air and steam out of the brew chamber 130 at the beginning and end of a brew cycle; the vacuum line can also draw a vacuum on the brew chamber 130 during a brew cycle to draw air through the filter 135, thereby agitating the must, as described below.)

The air supply 126 in the ground duct 124 can be activated as the piston 140 nears and then passes the ground window 133 toward the conclusion of a steep period in order to create positive pressure in the ground duct 124, thereby preventing steam from the brew chamber 130 from moving up into the ground duct 124. In particular, air displaced into the ground duct 124 by the air supply 126 can flow down into the brew chamber 130 via the ground duct 124, escape the brew chamber 130 via the vent window 134, and draw steam from the brew chamber 130 through the vent window 134, thereby preventing steam from moving toward and condensing within the ground duct 124, which may otherwise moisten ground output by the grinder 120 and cause these grounds to collect in the ground duct 124 before reaching the brew chamber 130. The vent window 134 can therefore cooperate with the air supply 126 to control evacuation of steam and moisture from the brew chamber 130 and to keep the grounds (relatively) dry.

In another implementation, the fixed chamber section 1₃1 (and the mobile chamber section 132) further includes a heating element 164 (e.g., a cartridge, band, heat sheet, or heat cable wrap heater) and a temperature sensor 181; the controller 180 can thus selectively activate the heating element 164 based on signals read from the temperature sensor 181 according to closed-loop controls in order to maintain the temperature of the must in the brew chamber 130 during a brew cycle.

### 6.3 Mobile Chamber Section

The mobile chamber section 132: is interposed between the filter 135 and the fixed chamber section 131; defines a mobile chamber section 132 that cooperates with the filter 135 and the fixed chamber section 131 to define a brew chamber 130 when located in the brew position; and functions to extract a “puck” of used grounds from the brew chamber 130 and to arrange this puck over a discard chute 156 (e.g., directly over a compost bin) for disposal—in preparation for a next brew cycle with fresh coffee grounds—when located in the discard position. In the brew position: the lower cylindrical section is coaxially aligned with the fixed chamber section 131 to form a substantially continuous cylinder between the filter 135 and the leading face of the piston 140; during a brew cycle, the piston 140 runs along this substantially continuous cylinder section. In the discard position: the mobile chamber section 132 is withdrawn from the upper cylindrical wall and is instead arranged over a discard chute 156 or directly over a waste bin 158 (e.g., a removable compost bin) and coaxial with a discard plunger 152, which can then eject used grounds from the mobile chamber section 132, as described below

In one implementation, the fixed chamber section 131: defines a rigid structure offset above the filter housing 136; and defines a upper sealing surface facing the filter 135 and extending across a second plane substantially parallel to the first plane. In this implementation, the mobile chamber section 132: defines a third rigid structure interposed between the filter housing 136 and the fixed chamber section 131; is arranged on a linear slide configured to advance and retract the mobile chamber section 132 parallel to the first and second planes; and includes a lower seal 138 encircling the mobile chamber section 132, facing the filter housing 136, and configured to seal against the lower seal 138ing surface around the filter 135 when the mobile chamber section 132 is in the brew position. In this implementation, the lower seal 138 can seal the mobile chamber section 132 to the filter 135, thereby enabling the filter 135 and mobile chamber section 132 to hold fluid during a steep period of a brew cycle. The mobile chamber section 132 can similarly include a upper seal 137 encircling the mobile chamber section 132, facing the fixed chamber section 131, and configured to seal against the upper sealing surface around the fixed chamber section 131 defined by the fixed chamber section 131 when the mobile chamber section 132 is in the brew position. The upper seal 137 can thus seal the mobile chamber section 132 to the fixed chamber section 131, thereby enabling the fixed and mobile chamber sections to hold fluid during a brew cycle. For example, the lower seal 138 can include a Teflon-coated silicone O-ring, and the mobile chamber section 132 can define a first face adjacent the filter 135 and defining a recess—of a depth less than (e.g., 60% of) the thickness of the seal—encircling the mobile chamber section 132. The lower seal 138 can thus be installed in and captured by the recess to seal the mobile chamber section 132 to the filter 135. The upper seal 137 can be of a similar geometry and material and similarly captured by the mobile chamber section 132.

The mobile chamber section 132 can be supported by a linear slide, and an ejection actuator 150 can advance and retract the linear slide to transition the linear slide between the brew and discard positions. For example, the ejection actuator 150 can include a rotary motor or linear actuator configured to drive the linear slide fore and aft, thereby transitioning the mobile chamber section 132 between the brew position (i.e., during a brew cycle) and the discard position (i.e., during a reset cycle). The brew chamber 130 can also include mechanical stops or limit switches that define the brew and discard positions; the controller 180 can selectively activate the ejection actuator 150 until a stop or limit switch is reached when transitioning the mobile chamber section 132 between the brew and discard positions. In particular, in the brew position, the linear slide locates the mobile chamber section 132 of the mobile chamber section 132 in coaxial alignment with the fixed chamber section 131 of the fixed chamber section 131; in the discard position, the linear slide locates the mobile chamber section 132 in coaxial alignment with a discard plunger 152 and/or discard chute 156, as described below. The mechanical stops or limit switches can therefore define target linear positions of the linear slide that locate the mobile chamber section 132 in the brew and discard positions. Alternatively, the system 100 can include an encoder arranged on the linear slide or on the ejection actuator 150; and the controller 180 can drive the ejection actuator 150 to target encoder positions in order to precisely locate the mobile chamber section 132 in the brew and discard positions.

The filter housing 136 can define a tapered surface declined away from the lower seal 138 surface; the lower seal 138—extending below the mobile chamber section 132—can thus ride up this tapered surface of the filter housing 136 as the ejection actuator 150 drives the mobile chamber section 132 into the brew position, thereby limiting wear to the lower seal 138 over multiple brew cycles over time. Similarly, the fixed chamber section 131 can define a tapered surface inclined away from the upper seal 137 surface; the upper seal 137—extending above the mobile chamber section 132—can thus ride down this tapered surface of the fixed chamber section 131 as the ejection actuator 150 drives the mobile chamber section 132 into the brew position, thereby limiting wear to the upper seal 137 over multiple brew cycles over time. (Alternatively, the first and upper seal 137s can be arranged on the filter housing 136 and the fixed chamber section 131, respectfully, and the mobile chamber section 132 can define the first and upper seal 137 surfaces.)

Yet alternatively, the filter housing 136 can extend laterally from the brew chamber 130 to the discard chute 156 and can define a bore over the discard chute 156 to enable used grounds retained by the mobile chamber section 132 in the discard position to be evacuated downward from the mobile chamber section 132 by the discard plunger 152, as described below; the lower seal 138 extending from the mobile chamber section 132 can thus run along and seal against the first surface defined by the filter housing 136 between the brew and discard positions, as shown in FIGS. 2 and 3. Similarly, the fixed chamber section 131 can extend laterally from the brew chamber 130 to over the discard chute 156 and can define a bore through which the discard plunger 152 passes to discharge used grounds from the mobile chamber section 132 in the discard position, as described below; the upper seal 137 extending from the mobile chamber section 132 can thus run along and seal against the second surface defined by the fixed chamber section 131 between the brew and discard positions.

### 6.4 Brew Chamber Variations

In one variation, the mobile chamber section 132 can be configured to pivot (i.e., rather than slide) between the brew and discard positions, and the ejection actuator 150 can be configured to actively rotate the mobile chamber section 132 between the brew and discard positions.

In another variation: the brew chamber 130 omits the lower brew chamber 130 section; the upper brew chamber 130 extends down to the filter housing 136; the disposal chute is coupled to the filter housing 136; and the filter housing 136 and the disposal chute are supported under the fixed chamber section 131 by a linear (or rotary) slide operable in a brew position and a discard position. In the brew position, the linear slide aligns the filter 135 within the fixed chamber section 131, and a seal extending across a lower face of the upper brew chamber 130 section seals against the filter housing 136. At the end of a steep period, the controller 180: triggers the ejection actuator 150 to move the linear slide to the discard position, thereby aligning the discard chute 156 with the fixed chamber section 131; and then triggers the brew chamber actuator 144 to drive the piston 140 downward, thereby forcing grounds out of the brew chamber 130 and down the discard chute 156.

However, the brew chamber 130 can define any other form and include any other active or passive elements that cooperate to define a volume in which coffee grounds can be steeped in heated water, in which coffee can be automatically discarded through a filter 135 into a cup (or pot, etc.), and in which used coffee grounds can be automatically discarded (e.g., into a compost bin).

### 7. Ground Duct and Air Supply

The ground duct 124 extends from the outlet of the grinder 120 to the ground window 133 in the brew chamber 130 and functions to funnel grounds from the grinder 120 into the brew chamber 130; the air supply 126 functions to release air under pressure into the ground duct 124; air flow into the brew chamber 130 thus also draws loose coffee grounds in the ground duct 124 toward the brew chamber 130 and across the filter 135, thereby preventing grounds from collecting in the ground duct 124. For example, the air supply 126 can include: a nozzle passing through the ground duct 124 proximal the outlet of the grinder 120 and configured to direct air toward the ground window 133; and a positive displacement air pump coupled to the nozzle.

In one implementation, while the piston 140 is retracted above the ground window 133 at the beginning of a brew cycle, the controller 180 can activate the air supply 126 to induce airflow into the brew chamber 130 and across the filter 135 and then (e.g., two seconds later) activate the primary grinder actuator. Once the primary grinder actuator 121 has been active for a target grinder 120 duration, the controller 180 maintains the air supply 126 in an active state for an additional duration (e.g., five seconds) or until the piston 140 is advanced down past the ground window 133 in order to ensure that substantially all grounds output by the grinder 120 enter the brew chamber 130.

As described above, the controller 180 can also activate the air supply 126 toward the end of a steep period in order to actively prevent steam in the brew chamber 130 from rising into the ground duct 124. For example, the controller 180 can activate the air supply 126 as the piston 140 approaches the ground window 133 and maintain the air supply 126 in this active state for an extended duration (e.g., one minute) after the mobile chamber section 132 is emptied and returned to the brew position following a brew cycle in order to cool the brew chamber 130 and to further prevent steam from entering the ground duct 124 prior to a next brew cycle. Alternatively, the controller 180 can maintain the air supply 126 in an active state at all times during a brew cycle and for a preset duration (e.g., one minute) following conclusion of a brew cycle.

In one variation, the system 100 can include a vacuum supply coupled to the vent window 134 and configured to draw air—and grounds—through the grinder 120, down the ground duct 124, and into the brew chamber 130. In this variation, the controller 180 can implement similar methods and techniques to activate the vacuum supply in order to draw grounds into the brew chamber 130 and to prevent steam from entering and condensing within the ground duct 124.

### 8. Piston and Brew Chamber Actuator

Generally, the piston 140 seals against and runs along the internal cylindrical walls defined by the fixed and mobile chamber sections (in the brew position); and the brew chamber actuator 144 functions to control the position of the piston 140 within the brew chamber 130 during a brew cycle.

In one implementation, the piston 140 defines a cylindrical structure configured to run along the brew chamber 130. The cylindrical structure can define a ring groove encircling its outer cylindrical surface and configured to retain a seal (e.g., an O-ring) that mates with the inner cylindrical walls of the fixed and mobile chamber sections as the piston 140 runs along the brew chamber 130, thereby sealing the top of the brew chamber 130 around the piston 140 against fluid egress.

As shown in FIG. 2, the piston 140 also defines: a fluid inlet 141 opposite the brew chamber 130 and fluidly coupled to the flexible fluid line; a set of fluid outlets 142 opposite the fluid inlet 141 and facing the brew chamber 130; and a manifold 143 fluidly coupling the fluid inlet 141 to the fluid outlets 142. In particular, fluid outlets 142 in the set can be arranged in a radial pattern configured to release water—entering the fluid inlet 141 and passing through the manifold 143—across a substantially large area of the filter 135 in order to achieve a high rate of wetting through the mass of grounds dispensed over the filter 135 and to achieve high efficiency in the total proportion of this mass of grounds that are fully wetted during the steep period, thereby yielding improved flavor extracting from the grounds into the must. More specifically, the system 100 can thus control contact between water and coffee grounds within the brew chamber as heated water is dispensed into the brew chamber such that mixing of water and coffee grounds is substantially uniformly distributed throughout the water dispensation period and such that these coffee grounds are evenly wetted from the start of the brew cycle, thereby yielding more precisely control of extraction of flavor from the coffee grounds.

For example, each fluid outlet 142 can define a narrow lozenge opening extending radially from the axial center of the piston 140 and across the bottom surface of the piston 140 facing the filter 135. Water entering the manifold 143 via the fluid inlet 141 can thus be drawn along each fluid outlet 142 via capillary action and then dispensed downward into the brew chamber 130 to wet grounds contained therein. Alternatively, each fluid outlet 142 can include a nozzle configured to spray droplets of water downward onto grounds contained in the brew chamber 130. Therefore, when the pump 162 displaces water from the buffer tank 166 into the fluid inlet 141 at the piston 140, the manifold 143 can distribute this water across multiple fluid outlets 142, which then spread this water across the cross-section of the brew chamber 130 to improve efficiency and effectiveness of the system 100 in wetting grounds contained in the brew chamber 130.

(Alternatively, the piston 140 can include multiple fluid inlet 141s, each paired with one fluid outlet 142 and fluidly coupled to one flexible fluid line; and each flexible fluid line can be coupled to the first fluid line via a manifold 143 located remotely from the piston 140.)

As shown in FIG. 2, the back side of the piston 140 is coupled to the brew chamber actuator 144. For example, the brew chamber actuator 144 can include a rotary actuator and can be coupled to the piston 140 via an eccentric and a connecting rod; as an output shaft of the brew chamber actuator 144 rotates, the eccentric and connecting rod can thus advance and retract the piston 140. In another implementation, the brew chamber actuator 144 includes a linear actuator, such as an electromechanical or electropneumatic linear actuator directly coupled to the piston 140. In yet another example, the brew chamber actuator 144 includes a rotary motor coupled to the piston 140 via a lead screw and a follower nut; the follower nut can be coupled to the piston 140, and the brew chamber actuator 144 can rotate the lead screw to move the follower nut along the lead screw, thereby advancing and retracting the piston 140. However, the brew chamber actuator 144 can be of any other type and coupled to the piston 140 in any other way.

Once the mobile chamber section 132 is advanced into the brew position during a brew cycle, the brew chamber actuator 144: withdraws the piston 140 to a reset position above the ground window 133 to enable grounds output by the grinder 120 to move down into the brew chamber 130 via the ground window 133; advances the piston 140 downward toward the filter 135 to an initial position below the ground window 133; retracts the piston 140 upward to accommodate fluid dispensed into the fluid chamber and then to draw ambient air into the brew chamber 130 throughout the steep period; advances the piston 140 back downward toward the filter 135 to eject fluid (i.e., coffee) from the brew chamber 130 via the filter 135 into a cup (or pot, etc.) below; and finally retracts the piston 140 back to the reset position above the ground window 133 in order to enable retracting of the mobile chamber section 132 to the discard position and in preparation for a next brew cycle.

The system 100 can also include an encoder or position sensor coupled to the brew chamber actuator 144, to a linkage between the brew chamber actuator 144 and the piston 140, or to the piston 140 directly; and the controller 180 can sample the encoder or position sensor throughout a brew cycle to track the position of the piston 140 within the brew chamber 130. The controller 180 can also implement closed-loop controls to control the position, rate of advancement, and rate of retraction of the piston 140 throughout a brew cycle. The system 100 can additionally or alternatively include a torque, power, or pressure sensor coupled to the brew chamber actuator 144, piston 140, or linkage therebetween and configured to output a signal corresponding to a vacuum level drawn in the brew chamber 130 when the piston 140 is retracted, pressure created in the brew chamber 130 when the piston 140 is advanced, and compression of used grounds between the piston 140 and the filter 135 when the piston 140 is fully advanced upon the conclusion of a steep period within a brew cycle. The controller 180 can then sample this torque, power, or pressure sensor throughout the brew cycle and implement closed-loop controls to maintain vacuum levels, pressure levels, and ground compaction to within preset threshold levels.

### 9. Waste Bin and Discard Plunger

As shown in FIG. 3, one variation of the system 100 further includes: a discard plunger 152 arranged over the discard chute 156 and configured to eject used grounds from the mobile chamber section 132 when occupying the discard position; and a waste bin 158 (e.g., a compost bin) configured to collect used grounds ejected from the mobile chamber section 132.

In one implementation, the waste bin 158 includes a removable compost bin aligned with the discard chute 156. In this implementation, the discard plunger 152 can include: a discard plunger 152 configured to run inside the mobile chamber section 132 of the mobile chamber section 132; and a plunger actuator 154 configured to advance the discard plunger 152 down through and below the mobile chamber section 132 to eject grounds from the mobile chamber section 132 and to retract the discard plunger 152 above the mobile chamber section 132 in order to permit the ejection actuator 150 to return the mobile chamber section 132 to the brew position. In this implementation, the discard plunger 152 can include a scraper (e.g., a rubber O-ring) encompassing its perimeter and configured to wipe grounds and moisture from the interior wall of the mobile chamber section 132. The discard position can also be perforated in order to limit adhesion between the leading face of the discard plunger 152 and used (or “spent,” “wet”) grounds in the mobile chamber section 132. Alternatively, the discard plunger 152 can include one or more nozzles coupled to the air supply 126, and the controller 180 can activate the air supply 126 while the plunger actuator 154 drives the discard position down toward used grounds in the mobile chamber section 132 in order to prevent used grounds from sticking to the leading face of the piston 140.

Therefore, the system 100 can further include: a waste bin 158 (or “compost bin”) arranged under the discard position; a plunger 152 arranged over the discard position; a plunger actuator 154 configured to drive the plunger 152 toward the discard position; and an ejection actuator 150 configured to transition the mobile chamber section 132 between the brew position and the discard position. In response to conclusion of the brew cycle, the controller 180 can initiate a reset cycle. During a reset cycle, the controller 180 can: trigger the brew chamber actuator 144 to drive the piston 140 toward the filter 135 to compress coffee grounds in the brew chamber 130 against the filter 135; trigger the brew chamber actuator 144 to retract the piston 140 to locate a leading face of the piston 140 within the fixed chamber section 131 proximal a junction between the fixed chamber section 131 and the mobile chamber section 132; trigger the ejection actuator 150 to retract the mobile section of the brew chamber 130 to the discard position; trigger the plunger actuator 154 to drive the plunger 152 toward the mobile chamber section 132 to displace coffee grounds from the mobile chamber section 132 into the waste bin 158; trigger the plunger actuator 154 to retract the plunger 152; and then trigger the ejection actuator 150 to advance the mobile chamber section 132 back to a brew position coaxial with the filter 135 and the fixed section of the brew chamber 130.

Alternatively, rather than include a discard plunger 152, the system 100 can include a pressure chamber over the discard chute 156 and coupled to the air supply 126; in the discard position, the mobile chamber section 132 of the mobile chamber section 132 can seal against the pressure chamber. To eject used grounds from the mobile chamber section 132, the controller 18o can open the air supply 126 to the pressure chamber, such as by opening a valve between the air supply 126 and the pressure chamber, thereby releasing a burst of air into the pressure chamber to force used grounds out of the mobile chamber section 132, down the ground duct 124, and into the waste bin 158 below.

Additionally or alternatively, the system 100 can include an actuator configured to impact or vibrate the mobile chamber section 132 to dislodge spent grounds from the mobile chamber section 132 into the waste bin.

However, the system 100 can include any other passive or active elements that cooperate to eject used grounds from the mobile chamber section 132 and to store these used grounds until removed by a user or operator.

### 2. Method

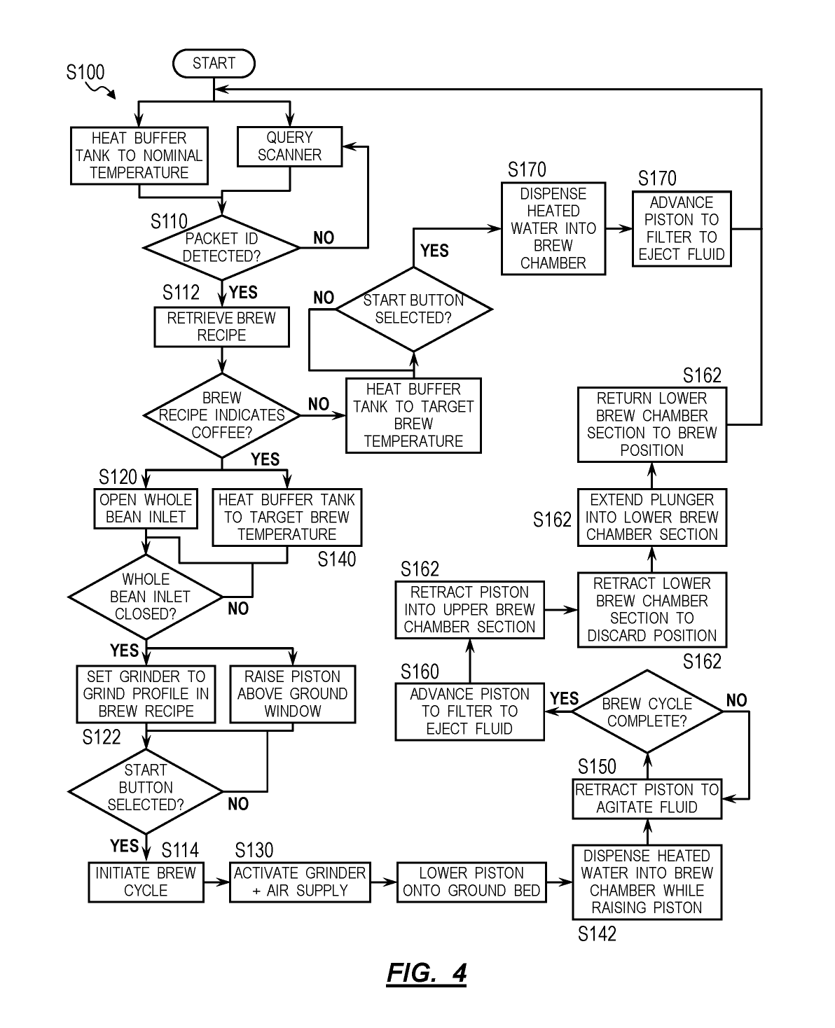

As shown in FIG. 4, the system 100 can execute a method for brewing a cup of coffee, including: reading an identifier from a packet proximal the system 100 in Block S110; accessing a brew recipe based on the identifier in Block S112; in response to the brew recipe indicating whole coffee beans in the packet, triggering a door actuator 114 to open an inlet door on the system 100 in Block S120; initiating a brew cycle according to the brew recipe in Block S114; in response to manual closure of the inlet door, activating a grinder 120, coupled to the inlet door, for a grind duration to grind whole beans manually dispensed from the packet through the inlet door during the brew cycle in Block S130; dispensing coffee grounds from the grinder 120 into a brew chamber 130 during the brew cycle in Block S132; heating a volume of water to a target temperature specified in the brew recipe during the brew cycle in Block S140; dispensing the volume of water into the brew chamber 130 during the brew cycle in Block S142; agitating the volume of water and coffee grounds in the brew chamber 130 during the brew cycle in Block S150; and, in response to conclusion of the brew cycle, triggering a brew chamber actuator 144 to actively transfer fluid out of the brew chamber 130 in Block S160.

The system 100 can execute a sequence of steps throughout a brew cycle to retrieve a brew recipe for a serving of whole coffee beans, to receive the serving of whole coffee beans, to grind the serving of whole coffee beans, to load coffee grounds into the brew chamber 130, to fill the brew chamber 130 with water at a volume and temperature specified in the brew recipe, to steep the grounds and water over a duration specified in the brew recipe, to discharge fluid from the brew chamber 130 into a cup, to evacuate used grounds from the brew chamber 130, and to then reset various elements in the system 100 in preparation for a next brew cycle.

### 2.1 Reset Cycle

In one implementation, upon conclusion of a previous brew cycle and prior to beginning a next brew cycle, the system 100 executes a reset cycle in Block S102. During a reset cycle, the controller 180: triggers the brew chamber actuator 144 to retract the piston 140 into the fixed chamber section 131 and above the ground window 133, as shown in FIG. 1; triggers the ejection actuator 150 to shift the mobile chamber section 132 from the brew position to the discard position; and triggers the plunger actuator 154 to drive the discard plunger 152 downward to clear used grounds from the mobile chamber section 132.

Once the mobile chamber section 132 is cleared of used grounds, the controller 180: triggers the plunger actuator 154 to withdraw the discard plunger 152 from the mobile chamber section 132; and triggers the ejection actuator 150 to return the mobile chamber section 132 to the brew position.

### 2.2 Packet Identifier and Brew Recipe

In preparation for a next brew cycle, the controller 180 can regularly sample the scanner 170 for a packet identifier, such as in the form of a barcode. For example, a user may select a packet labeled with a barcode and containing a serving of whole coffee grounds and then swipe the barcode across a field of view of an optical barcode scanner 170 integrated into the system 100. The scanner 170 can thus read the barcode from the packet and return the packet identifier to the controller 180 in Block S110; the controller 180 can then extract a brew recipe directly from the ID or pass the ID through a local or remote name mapping system to retrieve a brew recipe for the serving of whole coffee beans in Block S112.

Once the packet identifier is thus read and a corresponding brew recipe is thus accessed, the controller 180 can: trigger the secondary grinder actuator 122 to set the position of burr elements in the grinder 120 to a position corresponding to the ground profile specified in the brew recipe in Block S122; and trigger the inlet actuator to open the whole bean inlet no in Block S120, thus prompting the user to tear open the packet and dispense the contents of the packet into the whole bean inlet 110. (Alternatively, the controller 180 can adjust the position of the burr elements in the grinder 120 once the primary grind actuator is actuated at the beginning of the subsequent grind cycle, as described above.)

### 2.3 Heating Water

In one variation, once the user manually closes the whole bean inlet 110, the controller 180 can trigger one or more heating elements 164 within the system 100 to heat water stored in the system 100 (e.g., in the buffer tank 166) to a target brew temperature specified in the brew recipe. In particular, the system 100 can immediately begin heating water to the target temperature once the inlet door is manually closed and prior to the user selecting the start button, which may enable the system 100 to reach the target brew temperature in less time following selection of the start button.

Therefore, in Block S140, the system 100 can heat a volume of water to a target temperature specified in the brew recipe in response to manual closure of the inlet door.

### 2.4 Grinding Whole Beans

Once the user manually closes the whole bean inlet 110 and then manually selects a start (or similar) button on the system 100, the controller 180 can: activate the air supply 126 to the ground duct 124; then activate the primary grinder actuator 121 for a preset duration of time (e.g., 10 seconds, such as while also adjusting the burr element position to a position corresponding to the ground profile specified in the brew recipe) in Block S140; and then deactivate the air supply 126, such as five seconds after the primary grinder actuator 121 is deactivated, to displace last grounds from the grinder 120 into the brew chamber 130.

Alternatively, the system 100 can activate the grinder 120 immediately upon closure of the whole bean inlet 110.

In one example, the controller 180 can trigger the brew chamber actuator 144 to raise a leading face of a piston 140—running in the brew chamber 130—to a first position above a ground duct 124 connecting an outlet of the grinder 120 to the brew chamber 130, thereby opening this ground duct 124 between the outlet of the grinder 120 and brew chamber 13o; and the controller 180 can then activate the grinder 120 to grind and dispense coffee grounds from the grinder 120 into the brew chamber 130 between the filter 135 and the piston 140 over a grind duration. Therefore: the controller 180 can activate the grinder 120 for a grind duration to grind an entirety of the amount of whole coffee beans manually dispensed from the packet through the inlet door in Block S140; and the grinder 120 can grind and dispense an entirety of coffee grounds—ground from the entirety of the amount of whole coffee beans dispensed from the packet—into the brew chamber 130 during a brew cycle in Block S142.

### 2.5 Water Metering

In preparation to dispense heated water into the brew chamber 130, the controller 180 can trigger the brew chamber actuator 144 to drive the piston 140 down toward the filter 135, as shown in FIG. 2, thereby displacing air out of the brew chamber 130 via openings in the filter 135. In one implementation, the brew chamber actuator 144 drives the leading face of the piston 140 to an initial brew position above the filter 135. As the piston 140 approaches the initial brew position, the leading face of the piston 140 can: smooth a mass of grounds across the filter 135, which may improve lateral distribution of water throughout the grounds as close contact between adjacent grounds improves a rate at which water subsequently introduced to the brew chamber 130 wicks laterally (and vertically) through the grounds, which may in turn may improve flavor extraction from the coffee grounds and an improved flavor profile of the resulting cup of coffee. (In this implementation, the brew chamber actuator 144 can also drive the leading face of the piston 140 toward the filter 135 up to a target compression force, thereby compressing grounds between the piston 140 and the filter 135 into a puck, such as in preparation for brewing a volume of espresso.)

The controller 180 can then activate the pump 162 and the inline heating element 164 to dispense water—heated to a target temperature specified by the brew recipe—into the brew chamber 130 via the fluid inlet 141 and multiple fluid outlets 142 in the piston 140, thereby wetting the mass of grounds substantially uniformly. While fluid is dispensed into the brew chamber 130, the controller 180: samples the flow meter 182 to monitor a volume of water fluid dispensed into the brew chamber 130; and retracts the piston 140 at a rate that matches volumetric displacement of the piston 140 to a total volume of water supplied to the brew chamber 130 in order to maintain pressure within the brew chamber 130 at or slightly below ambient pressure, thereby preventing this water from being forced through the filter 135 prematurely. (The brew chamber actuator 144 can also retract the piston 140 at a rate sufficient to induce a vacuum within the brew chamber 130, which may assist the pump 162 in dispensing fluid into the brew chamber 130 at a more rapid rate and/or drawing ambient air into the brew chamber 130 to agitate the must even as fluid is dispensed into the brew chamber 130.)

Once the target volume of water is dispensed into the brew chamber 130, such as a standard volume or a volume specified by the brew recipe, the controller 180 can deactivate the pump 162.

Therefore, once coffee grounds output by the grinder 120 are loaded into the brew chamber 130 between the filter 135 and the piston 140, the controller 180 can: trigger the brew chamber actuator 144 to lower the leading face of the piston 140 to a second position below the ground duct 124; trigger the pump 162 to displace the volume of water into the brew chamber 130—between the filter 135 and the piston 140—in Block S142; and trigger the brew chamber actuator 144 to continuously withdraw the piston 140 away from the filter 135 at a rate proportional to a volume flow rate of water into the brew chamber 130 (e.g., at a rate equal to the volume flow rate divided by the cross-sectional area of the brew chamber 130). In this example, the controller 180 can also trigger the brew chamber actuator 144 to withdraw the piston 140 from the filter 135 at a rate (slightly) greater than a rate that compensates for influx of water into the brew chamber 130 in order to maintain pressure inside the brew chamber 130 below ambient pressure during the brew cycle, thereby preventing fluid from leaking out of the brew chamber 130.

### 2.6 Steeping

With water supply to the brew chamber 130 disabled, the brew chamber actuator 144 can continue to retract the piston 140 from the filter 135 in order to create vacuum within the brew chamber 130, which may draw ambient air into the brew chamber 130 via openings in the filter 135 (and/or past the lower seal 138 between the filter housing 136 and mobile chamber section 132). This ambient air may enter the brew chamber 130 in the form of bubbles, which may agitate the must, increase contact between the grounds and water, and thus improve flavor extraction from the grounds into the water, thereby yielding improved body in the resulting volume of coffee. Injection of such air bubbles may also oxidize tannins and stronger flavors in the must, which may yield a volume of coffee with a softer mouth feel and more balanced flavor, as described above.

In one example, the controller 180: retrieves a target brew time defined by the brew recipe; accesses a current position of the piston 140 within the brew chamber 130 once the target volume of fluid has been dispensed into the brew chamber 130; determines a maximum traversal distance for the piston 140 from its current position to a maximum retracted position below the ground window 133; and calculates a retraction rate for the piston 140 by dividing the maximum traversal distance by the target brew time (with a safety factor, such as 10%). Alternatively, the controller 180 can: implement a similar process to calculate a maximum retraction rate for the piston 140 or access a preset maximum retraction rate for the piston 140; access a preset minimum retraction rate for the piston 140, under which must in the brew chamber 130 may seep past the first and/or upper seal 137s or weep through the filter 135; and then set a retraction rate—between the minimum and maximum retraction rates—based on an agitation rate specified in the brew recipe. For example, the controller 180 can set a higher retraction rate for the piston 140 for a brew recipe that specifies greater agitation, and vice versa. The controller 180 can implement similar methods and techniques to define a dynamic (i.e., varying) retraction rate for the piston 140 based on a preferred agitation schedule specified in the brew recipe. For example, the controller 180 can define a dynamic retraction rate for the piston 140 starting at the maximum retraction rate and decreasing to the minimum retraction rate toward the end of the brew cycle given a brew recipe that specifies high agitation at the beginning of a brew cycle and minimal agitation at the end of the brew cycle. Yet alternatively, the controller 180 can retrieve a static present retraction rate for the piston 140. The system 100 can then retract the piston 140 according to this static or dynamic retraction rate throughout the remainder of brew cycle.

### 2.7 Steep Cessation and Dispensing

At the conclusion of the steep period, the controller 180 can trigger the brew chamber actuator 144 to drive the piston 140 down toward the filter 135, thereby increasing fluid pressure in the brew chamber 130 and forcing fluid—but not grounds—through openings in the filter 135 and into a cup (or pot, etc.) below. In particular, the controller 180 can drive the piston 140 downward at a rate that elevates pressure inside the brew chamber 130 to a level sufficient to force fluid through openings in the filter 135 but not sufficient to drive fluid past the first and upper seal 137s, past the pump 162, and/or past the valve (in the closed position). For example, the controller 180 can access a preset static advancement rate for the piston 140, set according to known pressure across through filter 135, a known sealing pressure of the first and upper seal 137s, and a known sealing pressure of the pump 162 and/or the valve in the closed position.

Therefore, the system 100 can hold the volume of water and coffee grounds within the brew chamber 130 during the brew cycle; and then trigger the brew chamber actuator 144 to force fluid out of the brew chamber 130—through the filter 135—over a dispense duration significantly less than a duration of the brew cycle in Block S160 in response to conclusion of the brew cycle.

### 2.8 Waste Removal

The brew chamber actuator 144 can continue to drive the piston 140 down toward the filter 135 in order to compress used grounds in the brew chamber 130 into a tight puck that is fully contained within the height of the mobile chamber section 132. Once this puck is formed, the brew chamber actuator 144 retracts the piston 140 back into the fixed chamber section 131 to complete the brew cycle and to start a reset cycle. With the piston 140 retracted back into the fixed chamber section 131 and used grounds formed into a puck in the mobile chamber section 132, the controller 180 triggers the plunger actuator 154 to withdraw the mobile chamber section 132 into the discard position such that the mobile chamber section 132—and therefore the puck of used grounds—is coaxial with the discard chute 156. The controller 180 can then trigger the plunger actuator 154 to advance the plunger 152 downward (and/or trigger the air supply 126 to supply a blast of air over the puck of used grounds, etc.) to force the puck out of the mobile chamber section 132, past the discard chute 156, and into the waste bin 158, as shown in FIG. 3. Finally, the plunger actuator 154 retracts the discard plunger 152, and the ejection actuator 150 returns the mobile chamber section 132 to the brew position in preparation for a next brew cycle, as shown in FIG. 1.

In particular, in response to conclusion of the brew cycle, the controller 180 can initiate a reset routine. During the reset routine, the controller 180 can: trigger the brew chamber actuator 144 to drive the piston 140 through a fixed section of the brew chamber 130 and a mobile section of the brew chamber 130 toward the filter 135 to compress coffee grounds in the brew chamber 130 against the filter 135, the mobile section of the brew chamber 130 interposed between the filter 135 and the fixed section of the brew chamber 130; trigger the brew chamber actuator 144 to retract the piston 140 to locate the leading face of the piston 140 within the fixed section of the brew chamber 130 proximal a junction between the fixed section of the brew chamber 130 and the mobile section of the brew chamber iso; trigger an ejection actuator 150 to retract the mobile section of the brew chamber 130 to a discard position between a plunger 152 and a waste bin 158, the discard position offset laterally from the filter 135 and the fixed section of the brew chamber 130; trigger a plunger actuator 154 to drive the plunger 152 toward the mobile section of the brew chamber 130 to displace coffee grounds from the mobile section of the brew chamber 130 into the waste bin 158; trigger the plunger actuator 154 to retract the plunger 152; and trigger the ejection actuator 150 to advance the mobile section of the brew chamber 130 back to a brew position coaxial with the filter 135 and the fixed section of the brew chamber 130.

### 2.9 Variation: Espresso

In one variation, the method S100 is similarly executed to brew a shot of espresso. In this variation, once espresso grounds are ground from whole beans and dispensed into the brew chamber 130, the controller 180 can drive the piston 140 downward toward the filter 135 to compress (or “tamp”) the espresso grounds into a “puck” in preparation for brewing. The controller 180 can then withdraw the piston 140 in preparation for dosing the brew chamber 130 with heated water. Once the brew chamber 130 is filled with the target volume of water, the controller 180 can again drive the piston 140 downward toward the piston 140 to achieve a relatively high pressure within the brew chamber 130 sufficient to eject a volume of espresso from the brew chamber 130 via the filter 135 (e.g., a espresso-specific filter 135 containing relatively small openings at relatively low density.) (Alternatively, the pump 162 can be configured to output a fluid pressure sufficient to drive water through a tamped puck of espresso grounds in the brew chamber. To brew a shot of espresso, the system 100 can: drive the piston down to tamp espresso grounds in the brew chamber; hold the piston in or near this tamp position; and then activate the pump to force heated water through fluid inlets 141 on the piston 140, through the tamped puck of espresso grounds, out the filter 135, and into a cup below.)

### 2.10 Variation: Alternative Hot Beverage

In one variation shown in FIG. 4, the system 100 interfaces with packets containing dry steeping or mixing materials for other hot beverages, such as tea or hot chocolate. In this variation: the scanner 170 can read an identifier from such a packet containing other than a coffee product; and the controller 180 can access a brew recipe for this packet based on this identifier, such as from a local or remote database of from the identifier itself. Once the controller 180 determines that this packet corresponds to a hot beverage other than coffee, the controller 180 can: trigger the heater to heat a volume of water to a target temperature specified in this brew recipe; trigger the pump 162 to dispense this volume of water into the brew chamber 130; and immediately trigger the brew chamber actuator 144 to actively transfer this volume of water out of the brew chamber 130—and into a cup below—in response to dispensation of this volume of water into the brew chamber 130 in Block S170. The system 100 can thus implement methods and techniques described above to dispense a metered volume of hot water through the brew chamber 130 and then immediately release this metered volume of hot water into a cup below (i.e., rather than steep this water inside the brew chamber 130). During this time, a user may dispense contents of the packet into a cup and place this cup under the filter 135 or other outlet of the brew chamber 130 to receive the metered volume of hot water.

However, the system 100 can implement any other method or technique to dispense a metered volume of hot water for any other type of hot beverage that may be steeped or mixed manually outside of the system 100.

The system s and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising, at a system configured to brew a cup of coffee:
reading an identifier from a packet proximal the system;
accessing a brew recipe based on the identifier;
in response to the brew recipe indicating whole coffee beans in the packet, triggering a door actuator to open an inlet door on the system;
initiating a brew cycle according to the brew recipe;
during the brew cycle:
in response to manual closure of the inlet door, activating a grinder, coupled to the inlet door, for a grind duration to grind whole beans manually dispensed from the packet through the inlet door;
dispensing coffee grounds from the grinder into a brew chamber;
heating a volume of water to a target temperature specified in the brew recipe;
dispensing the volume of water into the brew chamber; and
agitating the volume of water and coffee grounds in the brew chamber; and
in response to conclusion of the brew cycle, triggering a brew chamber actuator to actively transfer fluid out of the brew chamber.

2. The method of claim 1:
wherein reading the identifier from the packet comprises reading the identifier from the packet containing an amount of whole coffee beans corresponding to a single cup of coffee;
wherein activating the grinder comprises activating the grinder for the grind duration to grind an entirety of the amount of whole coffee beans manually dispensed from the packet through the inlet door; and
wherein dispensing coffee grounds from the grinder into the brew chamber comprises dispensing an entirety of coffee grounds, ground from the entirety of the amount of whole coffee beans, into the brew chamber during the brew cycle.

3. The method of claim 2:
wherein reading the identifier from the packet comprises reading a barcode arranged along a tearable region across a sealed mouth of the packet; and
wherein accessing the brew recipe comprises accessing the brew recipe associated with the barcode.

4. The method of claim 1, wherein activating the grinder comprises activating the grinder in response to manual closure of the inlet door followed by manual selection of a start button arranged on the system.

5. The method of claim 4:
further comprising, in response to accessing the brew recipe based on the identifier, activating a grind position actuator to set a position of the grinder according to a ground profile specified in the brew recipe;
wherein heating the volume of water comprises heating the volume of water to the target temperature specified in the brew recipe in response to manual closure of the inlet door; and
wherein initiating the brew cycle comprises initiating the brew cycle in response to manual closure of the inlet door followed by manual selection of the start button.

6. The method of claim 1, wherein accessing the brew recipe comprises extracting the brew recipe directly from the identifier, the brew recipe specifying the target temperature and a duration of the brew cycle.

7. The method of claim 1,
further comprising, during the brew cycle, holding the volume of water and coffee grounds within the brew chamber; and
wherein triggering the brew chamber actuator to actively transfer fluid out of the brew chamber comprises triggering the brew chamber actuator to force fluid out of the brew chamber, through a filter, over a dispense duration significantly less than a duration of the brew cycle.

8. The method of claim 1:
further comprising, at a first time, triggering the brew chamber actuator to raise a leading face of a piston, running in the brew chamber, to a first position above a ground duct connecting an outlet of the grinder to the brew chamber;
wherein dispensing coffee grounds into the brew chamber comprises, at a second time succeeding the first time, dispensing coffee grounds from the grinder into the brew chamber between a filter and the piston;
wherein dispensing the volume of water into the brew chamber comprises, at a fourth time succeeding the second time, dispensing the volume of water from the grinder into the brew chamber between the filter and the piston; and
wherein triggering the brew chamber actuator to actively transfer fluid out of the brew chamber comprises, in response to conclusion of the brew cycle at a fifth time succeeding the fourth time by a brew duration specified in the brew recipe, triggering the brew chamber actuator to drive the piston toward the filter to force fluid out of the brew chamber via the filter.

9. The method of claim 8:
further comprising, at a third time succeeding the second time, triggering the brew chamber actuator to lower the leading face of the piston to a second position below the ground duct; and
wherein dispensing the volume of water into the brew chamber comprises, at the fourth time succeeding the third time, pumping the volume of water into an inlet on a back side of the piston and into the brew chamber via a set of outlets arranged across the leading face of the piston.

10. The method of claim 9:
wherein agitating the volume of water and coffee grounds in the brew chamber comprises activating the brew chamber actuator to withdraw the piston away from the filter to draw air into the brew chamber via the filter to agitate the volume of water and coffee grounds during the brew cycle.

11. method of claim 8,
further comprising, at a third time succeeding the second time, triggering the brew chamber actuator to lower the leading face of the piston to a second position below the ground duct;
wherein dispensing the volume of water into the brew chamber comprises, at the fourth time succeeding the third time, pumping the volume of water into the brew chamber; and
further comprising activating the brew chamber actuator to continuously withdraw the piston away from the filter to maintain pressure inside the brew chamber below ambient pressure during the brew cycle to prevent fluid from leaking out of the brew chamber.

12. The method of claim 8, further comprising:
in response to conclusion of the brew cycle, initiating a reset routine;
during the reset routine:
triggering the brew chamber actuator to drive the piston through a fixed section of the brew chamber and a mobile section of the brew chamber toward the filter to compress coffee grounds in the brew chamber against the filter, the mobile section of the brew chamber interposed between the filter and the fixed section of the brew chamber;
triggering the brew chamber actuator to retract the piston to locate the leading face of the piston within the fixed section of the brew chamber proximal a junction between the fixed section of the brew chamber and the mobile section of the brew chamber;
triggering an ejection actuator to retract the mobile section of the brew chamber to a discard position between a plunger and a waste bin, the discard position offset laterally from the filter and the fixed section of the brew chamber;
triggering a plunger actuator to drive the plunger toward the mobile section of the brew chamber to displace coffee grounds from the mobile section of the brew chamber into the waste bin;
triggering the plunger actuator to retract the plunger; and
triggering the ejection actuator to advance the mobile section of the brew chamber back to a brew position coaxial with the filter and the fixed section of the brew chamber.

13. The method of claim 1, further comprising, during activation of the grinder, injecting air into a ground duct between an outlet of the grinder and a ground window at the brew chamber to displace coffee grounds from the ground duct into the brew chamber.

14. The method of claim 1, further comprising:
reading a second identifier from a second packet proximal the system;
accessing a second brew recipe based on the second identifier;
in response to the second identifier corresponding to a hot beverage other than coffee:
heating a second volume of water to a second target temperature specified in the second brew recipe;
dispensing the second volume of water into the brew chamber; and
in response to dispensation of the second volume of water into the brew chamber, triggering the brew chamber actuator to actively transfer the second volume of water out of the brew chamber.

15. A system for brewing a cup of coffee comprising:
a whole bean inlet;
a grinder configured to grind whole coffee beans, dispensed into the whole bean inlet, into coffee grounds;
a ground duct extending from an outlet of the grinder;
a brew chamber defined by:
a filter;
a fixed chamber section offset above the filter, defining an upper cylinder section coaxial with the filter, and defining a ground window configured to receive coffee grounds from the ground duct; and
a mobile chamber section interposed between the filter and the upper cylinder section, defining a lower cylinder section, and operable between a brew position in which the lower cylinder section is coaxial with the upper cylinder section and a discard position in which the lower cylinder section is offset from the upper cylinder section;
an air supply coupled to the ground duct and configured to impel coffee grounds output by the grinder toward the ground window;
a piston configured to run along the upper cylinder section and the lower cylinder section and defining a fluid inlet opposite the filter, a set of fluid outlets facing the filter, and a manifold configured to distribute fluid from the fluid inlet into the brew chamber via the set of fluid outlets; and
a brew chamber actuator configured to draw the piston away from the filter to draw air through the filter into the brew chamber during a brew cycle and to advance the piston toward the filter to drive fluid out of the brew chamber through the filter in response to conclusion of the brew cycle.

16. The system of claim 15, further comprising:
an inlet door arranged across the whole bean inlet;
a door actuator configured to open the inlet door;
a reservoir configured to store water;
a heating element configured to heat water drawn out of the reservoir;
a pump configured to displace water between the reservoir into the brew chamber;
a scanner configured to read an identifier from a packet proximal the whole bean inlet; and
a controller configured to:
access a brew recipe based on the identifier;
trigger the door actuator to open the inlet door in response to the brew recipe indicating whole coffee beans in the packet;
initiate a brew cycle according to the brew recipe in response to manual closure of the inlet door;
during the brew cycle:
activate the grinder for a grind duration to grind whole beans manually dispensed from the packet into the whole bean inlet via the inlet door;
activate the heating element to heat a volume of water to a target temperature specified in the brew recipe;
activate the pump to dispense the volume of water into the brew chamber via the inlet; and
activate the brew chamber actuator to retract the piston from the filter to draw air into the brew chamber to agitate the volume of water and coffee grounds in the brew chamber; and
activate the brew chamber actuator to advance the piston toward the filter to transfer fluid out of the brew chamber via the filter in response to conclusion of the brew cycle.

17. The system of claim 16:
further comprising a start button proximal the whole bean inlet;
wherein the scanner comprises a barcode scanner configured to read the identifier comprising a barcode arranged on the packet, the packet containing an amount of whole coffee beans corresponding to a single cup of coffee; and
wherein the controller is configured to activate the grinder to grind the amount of whole coffee beans dispensed from the packet into the whole bean inlet in response selection of the start button following manual closure of the inlet door.

18. The system of claim 17, wherein the scanner is configured to read the barcode comprising a destructible barcode arranged along a tearable region across a sealed mouth of the packet.

19. The system of claim 16, wherein the controller is further configured to, during the brew cycle:
trigger the brew chamber actuator to raise the piston above a junction of the ground duct at the brew chamber to open the brew chamber to receive coffee grounds from the grinder at a first time;
at a second time succeeding the first time by the grind duration, trigger the brew chamber actuator to lower the piston to an initial position over the filter; and
trigger the brew chamber actuator to retract the piston from the initial position at a rate proportional to a flow rate of the volume of water into the brew chamber and based on a cross-sectional area of the piston.

20. The system of claim 16:
further comprising:
a waste bin arranged under the discard position;
a plunger arranged over the discard position;
a plunger actuator configured to drive the plunger toward the discard position; and
an ejection actuator configured to transition the mobile chamber section between the brew position and the discard position;
wherein the controller is further configured to:
initiate a reset cycle in response to conclusion of the brew cycle;
during the reset cycle:
trigger the brew chamber actuator to drive the piston toward the filter to compress coffee grounds in the brew chamber against the filter;
trigger the brew chamber actuator to retract the piston to locate a leading face of the piston within the fixed chamber section proximal a junction between the fixed chamber section and the mobile chamber section;
trigger the ejection actuator to retract the mobile section of the brew chamber to the discard position;
trigger the plunger actuator to drive the plunger toward the mobile chamber section to displace coffee grounds from the mobile chamber section into the waste bin;
trigger the plunger actuator to retract the plunger; and
trigger the ejection actuator to advance the mobile chamber section back to a brew position coaxial with the filter and the fixed section of the brew chamber.
